(19) United States
(12) Patent Application Publication
(10) Pub. No.: US 2016/0255653 A1
(43) Pub. Date: Sep. 1, 2016

(54) METHODS AND APPARATUS FOR SELECTIVE CONTENTION IN A MIXED WIRELESS COMMUNICATION SYSTEM

(71) Applicant: QUALCOMM Incorporated, San Diego, CA (US)

(72) Inventors: Rahul Malik, San Diego, CA (US); Hemanth Sampath, San Diego, CA (US); Simone Merlin, San Diego, CA (US); Alfred Asterjadhi, San Diego, CA (US)

(21) Appl. No.: 15/051,471

(22) Filed: Feb. 23, 2016

Related U.S. Application Data
(60) Provisional application No. 62/126,433, filed on Feb. 27, 2015.
(60) Provisional application No. 62/126,434, filed on Feb. 27, 2015.
(60) Provisional application No. 62/126,427, filed on Feb. 27, 2015.
(60) Provisional application No. 62/126,436, filed on Feb. 27, 2015.
(60) Provisional application No. 62/126,431, filed on Feb. 27, 2015.

(51) Int. Cl. H04W 74/08

(52) U.S. Cl. CPC H04W 74/08; H04W 84/12

(57) ABSTRACT

Certain aspects of the present disclosure relate to a methods and apparatus for wireless communication. In one aspect, a method for communication over a wireless medium includes transmitting, from a first wireless device, a first communication reserving access to the wireless medium during a first time period. The method further includes transmitting a second communication selectively allowing one or more wireless devices to access the wireless medium, regardless of a reservation specified by the first communication, during a second time period. The method further includes transmitting, after the second time period, a third communication reserving access to the wireless medium during a third time period.

### PRIORITY CLAIM

This application claims the benefit of U.S. Provisional Application No. 62/126,433, filed Feb. 27, 2015; U.S. Provisional Application No. 62/126,434, filed Feb. 27, 2015; U.S. Provisional Application No. 62/126,427, filed Feb. 27, 2015; U.S. Provisional Application No. 62/126,436, filed Feb. 27, 2015; and U.S. Provisional Application No. 62/126,431, filed Feb. 27, 2015; each of which is hereby incorporated herein by reference in its entirety.

### FIELD

Certain aspects of the present disclosure generally relate to wireless communications, and more particularly, to methods and apparatus for selective contention in a mixed wireless communication system.

### BACKGROUND

For increasing volume and complexity of information communicated wirelessly between multiple devices in a wireless communication system, the requirement for managing a level of acceptable interference continues to increase. Such devices may operate in close proximity to one another while operating over a common frequency spectrum in accordance with different communication standards. Two of such systems standards are commonly known as long-term evolution (LTE) and wireless local area network (WLAN). Use of a common frequency by different devices inherently creates the possibility of experiencing interference while such devices are accessing the communication resources. Certain governmental regulatory agency makes spectrum available for wireless services, including licensed and unlicensed spectrums. Generally, wireless communications over the licensed frequencies are limited to one or more particular use and location. The licensed frequency spectrum has generally been provided for Cellular Market Areas (CMAs). The frequency spectrum designated as “unlicensed” or “licensed-exempt,” allows the users to freely operate wireless devices while complying with certain technical requirements, including transmission power limits. Users of the unlicensed frequency spectrum do not have exclusive use of the spectrum and are subject to interference by other users.

Generally, the particulars of the system protocol for operating in the licensed and unlicensed frequency spectrums may be different. The LTE standard allows LTE devices to operate in both licensed and unlicensed frequency spectrums. The WLAN devices may also be operating in the same unlicensed frequency spectrum. The LTE devices operating in the unlicensed frequency spectrum are generally known as LTE-U devices. LTE-U and WLAN devices may utilize a common frequency spectrum at essentially the same time or overlapping time periods. To reduce and possibly avoid a level of interference experienced by LTE-U and WLAN devices operating in a common unlicensed frequency spectrum, there is a need for controlling and managing use of the wireless communication resources.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method of communication over a wireless medium. The method includes transmitting, from a first wireless device, a first communication reserving access to the wireless medium during a first time period. The method further includes transmitting a second communication selectively allowing one or more wireless devices to access the wireless medium, regardless of a reservation specified by the first communication, during a second time period. The method further includes transmitting, after the second time period, a third communication reserving access to the wireless medium during a third time period.

In various embodiments, the second time period can be a subset of the first time period. In various embodiments, the second communication clears a network allocation vector (NAV), set by the first communication, for a duration of the second time period. In various embodiments, the second communication indicates a time after which the one or more wireless devices should not transmit.

In various embodiments, the second communication indicates a duration for which the one or more wireless devices may transmit. In various embodiments, the second communication indicates a time at which the one or more wireless devices should set a network allocation vector (NAV) to a maximum value.

In various embodiments, the method can further include a transmitting a fourth communication clearing the NAV. In various embodiments, the second communication indicates a time at which the one or more wireless devices should set or reset a network allocation vector (NAV) to a first value.

In various embodiments, the third communication indicates that the one or more wireless devices should set a network allocation vector (NAV) to a second value, greater than the first value. In various embodiments, the second communication can be decodable only by a subset of a plurality of devices on a wireless network. In various embodiments, the second communication identifies one or more wireless devices allowed to access the wireless medium.

In various embodiments, the second communication identifies one or more access classes that are allowed to contend for access to the wireless medium. In various embodiments, the second communication identifies one or more devices utilizing one or more technology types that are allowed to access the medium. In various embodiments, the first wireless device includes a long term evolution unlicensed (LTE-U) device and the first communication includes a wireless local area network (WLAN) communication.

In various embodiments, the second communication includes a public action frame. In various embodiments, the second communication includes a control frame. In various embodiments, the second communication includes a frame carrying a vendor specific information element (IE).

Another aspect provides an apparatus configured to communicate over a wireless medium. The apparatus includes a processor configured to generate a first communication reserving access to the wireless medium during a first time period. The processor is further configured to generate a second communication selectively allowing one or more wireless devices to access the wireless medium, regardless of a reservation specified by the first communication, during a second time period. The processor is further configured to generate, for transmission after the second time period, a third communication reserving access to the wireless medium during a third time period. The apparatus further includes a transmitter configured to transmit the first, second, and third communications.

In various embodiments, the second time period can be a subset of the first time period. In various embodiments, the second communication clears a network allocation vector (NAV), set by the first communication, for a duration of the second time period. In various embodiments, the second communication indicates a time after which the one or more wireless devices should not transmit.

In various embodiments, the second communication indicates a duration for which the one or more wireless devices may transmit. In various embodiments, the second communication indicates a time at which the one or more wireless devices should set a network allocation vector (NAV) to a maximum value. In various embodiments, the transmitter can be further configured to transmit a fourth communication clearing the NAV.

In various embodiments, the second communication indicates a time at which the one or more wireless devices should set or reset a network allocation vector (NAV) to a first value. In various embodiments, the third communication indicates that the one or more wireless devices should set a network allocation vector (NAV) to a second time, greater than the first time.

In various embodiments, the second communication can be decodable only by a subset of a plurality of devices on a wireless network. In various embodiments, the second communication identifies one or more wireless devices allowed to access the wireless medium. In various embodiments, the second communication identifies one or more access classes that are allowed to contend for access to the wireless medium.

In various embodiments, the second communication identifies one or more devices utilizing one or more technology types that are allowed to access the medium. In various embodiments, the apparatus includes a long term evolution unlicensed (LTE-U) device and the first communication includes a wireless local area network (WLAN) communication.

In various embodiments, the second communication includes a public action frame. In various embodiments, the second communication includes a control frame. In various embodiments, the second communication includes a frame carrying a vendor specific information element (IE).

Another aspect provides another apparatus for communication over a wireless medium. The apparatus includes means for transmitting a first communication reserving access to the wireless medium during a first time period. The apparatus further includes means for transmitting a second communication selectively allowing one or more wireless devices to access the wireless medium, regardless of a reservation specified by the first communication, during a second time period. The apparatus further includes means for transmitting, after the second time period, a third communication reserving access to the wireless medium during a third time period.

In various embodiments, the second time period can be a subset of the first time period. In various embodiments, the second communication clears a network allocation vector (NAV), set by the first communication, for a duration of the second time period. In various embodiments, the second communication indicates a time after which the one or more wireless devices should not transmit.

In various embodiments, the second communication indicates a duration for which the one or more wireless devices may transmit. In various embodiments, the second communication indicates a time at which the one or more wireless devices should set a network allocation vector (NAV) to a maximum value. In various embodiments, the apparatus can further include means for transmitting a fourth communication clearing the NAV.

In various embodiments, the second communication indicates a time at which the one or more wireless devices should set or reset a network allocation vector (NAV) to a first value. In various embodiments, the third communication indicates that the one or more wireless devices should set a network allocation vector (NAV) to a second value, greater than the first value.

In various embodiments, the second communication can be decodable only by a subset of a plurality of devices on a wireless network. In various embodiments, the second communication identifies one or more wireless devices allowed to access the wireless medium. In various embodiments, the second communication identifies one or more access classes that are allowed to contend for access to the wireless medium.

In various embodiments, the second communication identifies one or more devices utilizing one or more technology types that are allowed to access the medium. In various embodiments, the apparatus includes a long term evolution unlicensed (LTE-U) device and the first communication includes a wireless local area network (WLAN) communication. In various embodiments, the second communication includes a public action frame. In various embodiments, the second communication includes a control frame. In various embodiments, the second communication includes a frame carrying a vendor specific information element (IE).

Another aspect provides a non-transitory computer-readable medium. The medium includes code that, when executed, causes an apparatus to transmit a first communication reserving access to the wireless medium during a first time period. The medium further includes code that, when executed, causes the apparatus to transmit a second communication selectively allowing one or more wireless devices to access the wireless medium, regardless of a reservation specified by the first communication, during a second time period. The medium further includes code that, when executed, causes the apparatus to transmit, after the second time period, a third communication reserving access to the wireless medium during a third time period.

In various embodiments, the second time period can be a subset of the first time period. In various embodiments, the second communication clears a network allocation vector (NAV), set by the first communication, for a duration of the second time period. In various embodiments, the second communication indicates a time after which the one or more wireless devices should not transmit.

In various embodiments, the second communication indicates a duration for which the one or more wireless devices may transmit. In various embodiments, the second communication indicates a time at which the one or more wireless devices should set a network allocation vector (NAV) to a maximum value. In various embodiments, the medium can further include code that, when executed, causes the apparatus to transmit a fourth communication clearing the NAV.

In various embodiments, the second communication indicates a time at which the one or more wireless devices should set or reset a network allocation vector (NAV) to a first value. In various embodiments, the third communication indicates that the one or more wireless devices should set a network allocation vector (NAV) to a second value, greater than the first value.

In various embodiments, the second communication can be decodable only by a subset of a plurality of devices on a wireless network. In various embodiments, the second communication identifies one or more wireless devices allowed to access the wireless medium. In various embodiments, the second communication identifies one or more access classes that are allowed to contend for access to the wireless medium.

In various embodiments, the second communication identifies one or more devices utilizing one or more technology types that are allowed to access the medium. In various embodiments, the apparatus includes a long term evolution unlicensed (LTE-U) device and the first communication includes a wireless local area network (WLAN) communication.

In various embodiments, the second communication includes a public action frame. In various embodiments, the second communication includes a control frame. In various embodiments, the second communication includes a frame carrying a vendor specific information element (IE).

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3A illustrates a time sequence diagram of exemplary communications between LTE and WLAN devices, according to one embodiment.

FIG. 3B illustrates a time sequence diagram of exemplary communications between LTE and WLAN devices, according to another embodiment.

FIG. 3C illustrates a time sequence diagram of exemplary communications between LTE and WLAN devices, according to another embodiment.

FIG. 4 shows a flowchart for an example method of wireless communication that can be employed within the wireless communication system of FIG. 1.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently or combined with any other aspect of the disclosure. In addition, the scope is intended to cover such an apparatus or method which is practiced using other structure and functionality as set forth herein. It should be understood that any aspect disclosed herein may be embodied by one or more elements of a claim.

Although particular aspects are described herein, variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary’ is not necessarily to be construed as preferred or advantageous over other implementations. The following description is presented to enable any person skilled in the art to make and use the embodiments described herein. Details are set forth in the following description for purpose of explanation. In other instances, well-known structures and processes are not elaborated in order not to obscure the description of the disclosed embodiments with unnecessary details. Thus, the present application is not intended to be limited by the implementations shown, but is to be accorded with the broad scope consistent with the principles and features disclosed herein.

A WLAN device as described herein may use the protocols described in any of the 802.11 family of standards, such as 802.11a, 802.11ah, 802.11ac, 802.11n, 802.11g, 802.11b, and others. The WLAN device may be an access point (“AP”), or a station (“STA”). In general, an AP serves as a hub or a base station for the STAs in the communication network. An STA may be a laptop computer, a personal digital assistant (PDA), a mobile phone, etc. In general, an STA wirelessly connects to an AP via an IEEE 802.11 protocol communication link to have, for example, a wireless connectivity to the Internet, other devices and other networks. An STA may also operate as an AP.

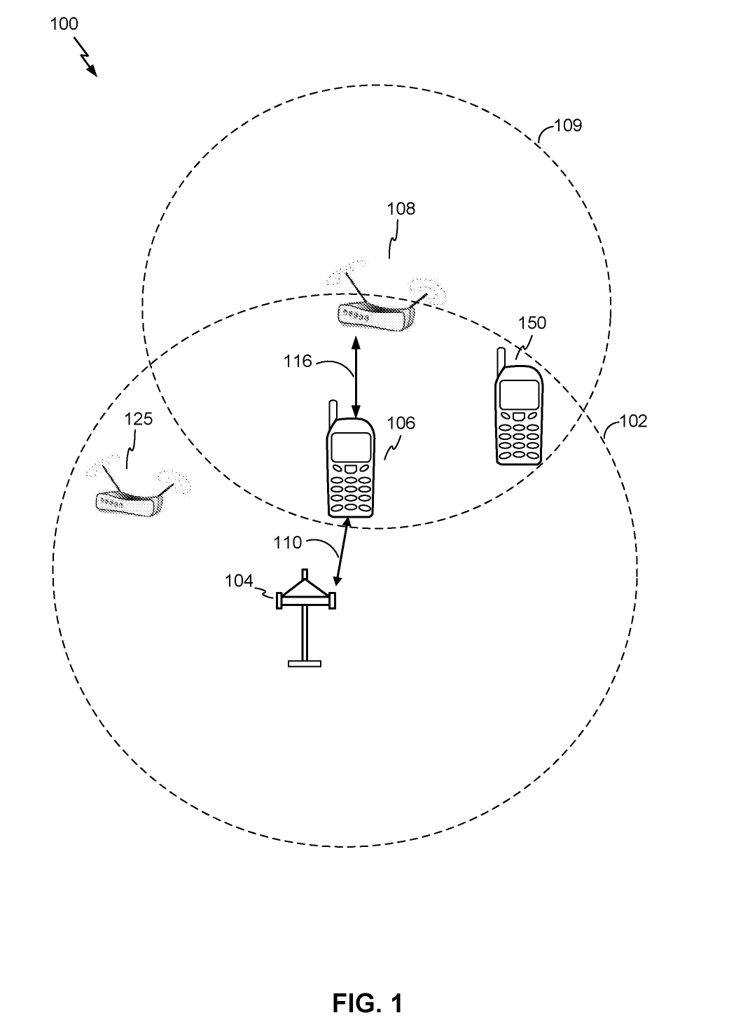

FIG. 1 illustrates an example of a wireless communication system 100 that may be incorporating various aspects of the present disclosure. Wireless communication system 100 may include an STA 106, a base station (BS) 104 and an AP 108. The BS 104 may provide wireless communication coverage in a coverage area 102. The AP 108 may provide wireless communication coverage in a basic service area (BSA) 109. The wireless communications in coverage area 102 and BSA 109 may include communications in an unlicensed frequency spectrum. A wireless communication connectivity service in accordance with LTE-U protocols may be provided by BS 104. Providing such a service includes at least transmission of LTE-U communications (e.g., data packets). In accordance with an embodiment, WLAN communications may also be transmitted by BS 104, for example, for data communications or to protect the LTE-U communications. Therefore, in accordance with an embodiment, a wireless communication link 110 between BS 104 and STA 106 may include transmission and reception of data packets in accordance with LTE-U and WLAN protocols. The AP 108 may communicate with STA 106 over a wireless communication link 116 in accordance with WLAN protocols in the unlicensed frequency spectrum. As such, wireless communication link 110 and wireless communication link 116 may occur over a common unlicensed frequency spectrum at the same time or overlapping time periods.

Embodiments described herein are particularly related to coexisting operations of LTE-U and WLAN devices using common communication resources (e.g., frequency spectrum and transmission time). Generally, wireless communication system 100 includes many different devices aspects of which may operate over a common unlicensed frequency spectrum. Some of these devices may be operating in accordance with WLAN standards (WLAN devices) and while others in accordance with the LTE-U protocol (LTE-U devices). The LTE-U and WLAN wireless communication links with such devices may occur at essentially the same time or overlapping time periods. Sharing communication resources such as the frequency spectrum and the available transmission times typically create coexistence problems for devices operating in accordance with two different protocols (e.g., LTE-U and WLAN). Generally, the WLAN devices may not detect the presence of an LTE-U signal, and thus being unaware of the presence of LTE-U communication while transmitting WLAN signals. Such coexisting operations would cause interference for the LTE-U communications, and may limit access for the LTE-U device to the same frequency spectrum during desired time periods. The LTE-U communications may also be causing interference for the WLAN communications. As a result, the WLAN and the LTE-U devices may experience degradation of communication data throughput as well as collisions of transmitted signals. Various aspects of the disclosure improve the efficiency of using the unlicensed frequency spectrum in wireless communication system 100 where the possibility exists for different transmissions to occur in accordance with WLAN and LTE-U protocols. In accordance with an embodiment, BS 104, while providing wireless connectivity services in accordance with LTE-U protocol protocols, transmits WLAN communications.

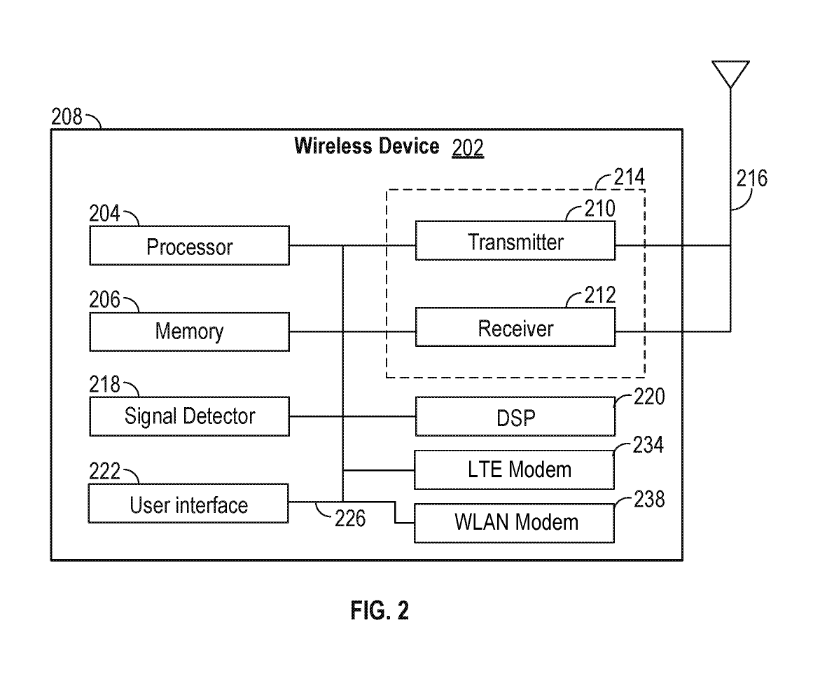

For example, the illustrated wireless communication system 100 may further include an AP 125 and user equipment (UE) 150 operating within the coverage area 102. Both the AP 125 and the UE 150 may receive communications from the BS 104. The AP 125 and UE 150 may adjust their operations in response to receiving such communications. In some embodiments, the AP 125 may include hardware and/or software (e.g., LTE Modem 234 and WLAN Modem 238 shown in FIG. 2) such that it is able to decode reception of certain LTE-U network information. For example, the AP 125 may decode, embedded within a WLAN communication, information regarding reception of an LTE-U communication or LTE-U network information.

In accordance with various aspects of the disclosure and as described in more detail below, wireless communications typically coexistence problems occur when different systems operate by sharing the same communication resources, such as time and frequency resources. For example, an LTE-U signal (for example, over the communication link 110) may be received at a level that is below the energy detection level at a WLAN device (such as the AP 108). Accordingly, WLAN devices may be unaware of LTE-U communications and may transmit during LTE-U communications which would interfere with the LTE-U communication as well as the LTE-U communication interfering with the WLAN communications. In such scenarios, both the WLAN and the LTE-U devices may experience throughput degradation from interference and collisions between the two communication protocols. It may be desirable to WLAN devices to detect LTE-U devices and LTE-U communications so that the WLAN devices may adjust their operation to improve throughput and communication efficiency of the system. Embodiments described herein relate to coexistence between LTE-U and WLAN devices, however, they may also apply to other RATs and protocols.

In accordance with an embodiment, the BS 104 may transmit a WLAN communication called a selective contention period (SCP) communication, which can indicate circumstances under which WLAN communications are allowed during a period in which LTE-U communications are not being transmitted. Such circumstances can include specific time periods during which WLAN communications are allowed, specific WLAN devices (or groups) that are allowed to transmit, and so on. In various embodiments, the BS 104 can reduce the likelihood of interference with the SCP communication by protecting the SCP with one or more other WLAN communications.

FIG. 2 illustrates various components of a wireless device 202 for operation in the wireless communication system 100. The wireless device 202 is suitable for performing the operations as may be required by BS 104, AP 108 or STA 106. The wireless device 202 may be configured and used differently for BS 104, AP 108 or STA 106 depending on the various operations that may be required in wireless communication system 100.

The wireless device 202 may include a processor 204 which may control operation of wireless device 202. Processor 204 may also be referred to as a central processing unit (CPU) or hardware processor. Processor 204 typically performs logical and arithmetic operations based on program instructions stored within a memory 206 which may include both read-only memory (ROM) and random access memory (RAM). A portion of memory 206 may also include non-volatile random access memory (NVRAM). The instructions in memory 206 may be executable to implement various aspects described herein. Processor 204 may include or be a component of a processing system implemented with one or more processors and may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

Processor 204 and memory 206 may include non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. The processor 204 may further include a data packet generator to generate data packets for controlling operation and data communication.

Wireless device 202 may include a transmitter 210 and a receiver 212 to allow wireless transmission and reception of data. Transmitter 210 and receiver 212 may be combined into a transceiver 214. An antenna 216 may be electrically coupled to transceiver 214. Although not shown, wireless device 202 may include multiple transmitters, multiple receivers, and/or multiple antennas. In an embodiment, although not shown, an antenna may be dedicated for each of the LTE-U and WLAN communications. Moreover, a receiver and a transmitter may be dedicated to for each of the LTE-U and WLAN communications. The operations associated with LTE-U and WLAN communications may also be performed collectively by the same receiver and transmitter. Wireless device 202 may be enclosed by a housing unit 208.

Wireless device 202 may also include an LTE modem 234 for LTE-U communications. Wireless device 202 may also include a WLAN modem 238 for WLAN communication. LTE modem 234 and WLAN modem 238 may contain processing capabilities for operations associated with processing at both the physical (PHY) layer and the medium access control (MAC) layer of the corresponding LTE-U and WLAN protocols. Although LTE modem 234 and WLAN modem 238 are shown separately, one of ordinary skill in the art may appreciate that the functions performed by these two components may be performed by a common component of wireless device 202, or their functions can be linked via hardware and/or software. Moreover, the functions associated with LTE modem 234 and WLAN modem 238 may also be performed by other components such as processor 204 and a digital signal processor (DSP) 220.

Wireless device 202 may transmit and receive both LTE-U and WLAN communications over antenna 216, transmitter 210, and receiver 212, each of which may be operationally connected to LTE modem 234 and WLAN modem 238. As disclosed herein, wireless device 202 may not require all the functionalities and components as shown and described when wireless device 202 is being used and implemented in AP 108, BS 104 or STA 106. In accordance with the disclosure, the basic functionality of WLAN modem 238 may be limited to processing transmission of WLAN data packets. For example, wireless communication link 110 between BS 104 and STA 106 may include transmission and reception of LTE-U communication and transmission of WLAN communications. Therefore, in BS 104, the basic functionality of WLAN modem 238 may be limited to processing transmission of WLAN communications.

Wireless device 202 may also include a signal detector 218 to detect and quantify the level of received signals. Signal detector 218 may detect such signals in a form of detecting total energy, energy per subcarrier per symbol, power spectral density and others. Wireless device 202 may also include DSP 220 for use in processing signals. DSP 220 may operationally be connected and share resources with processor 204 and other components.

Wireless device 202 may further include a user interface 222 in some aspects. User interface 222 may include any element such as a keypad, a microphone, a speaker, and/or a display for conveying information to a user of wireless device 202 and/or receives input from the user. Various components of wireless device 202 may be coupled together by a bus system 226 which may include for example a data bus, a power bus, a control signal bus, and a status signal bus.

Although a number of separate components are illustrated in FIG. 2, one of ordinary skill in the relevant art would appreciate that one or more of these components may be implemented not only with respect to the functionality described above, but also to perform the functionality associated with respect to other components. For example, processor 204 may be used to perform not only the functionality described with respect to processor 204, but also the functionality associated with signal detector 218 and/or DSP 220. Each of the components illustrated in FIG. 2 may be implemented using a plurality of separate elements.

In an exemplary embodiment, BS 104 may be configured for communicating in accordance with the operation of LTE-U protocol while also configured to transmit in accordance with the WLAN protocol. As such, when wireless device 202 is configured to operate as BS 104, the WLAN modem 238 can be configured to form and facilitate transmission of such WLAN communications from BS 104. Further, in accordance with an embodiment, when transmitted by BS 104, the WLAN communication is embedded with information about a selective contention period (SCP) in which WLAN devices (or a subset thereof) can transmit WLAN communications without interference by LTE-U communications. The transmission of the WLAN communication may be incorporated with LTE-U communications for improving or ensuring availability of frequency spectrum and timing resources for the LTE-U communications to take place having reduced receive interference from other possible WLAN communications in the unlicensed frequency spectrum. BS 104 while incorporating transmission of a WLAN communication with LTE-U communications to STA 106 or any other device reduces the possibility of experiencing interference at a receiver of the LTE-U communication from transmission of WLAN communication by other WLAN devices in the wireless communication system 100. While referring to a configuration of wireless device 202 in BS 104, processor 204 or DSP 220 may operate with LTE modem 234 and WLAN modem 238 for generating and transmitting the WLAN communication and the LTE-U communication in accordance with an exemplary embodiment. In accordance with an embodiment, the WLAN communication may also be embedded with information about LTE-U communication.

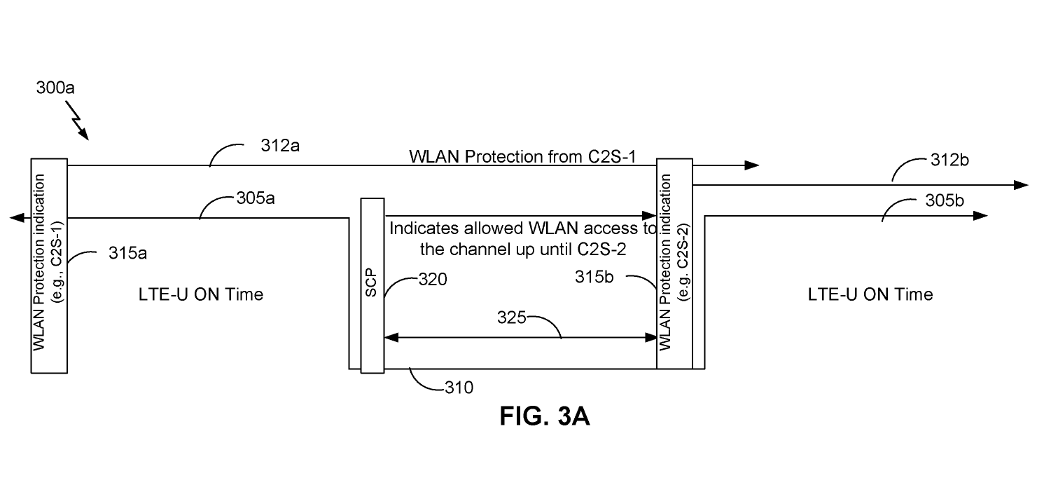

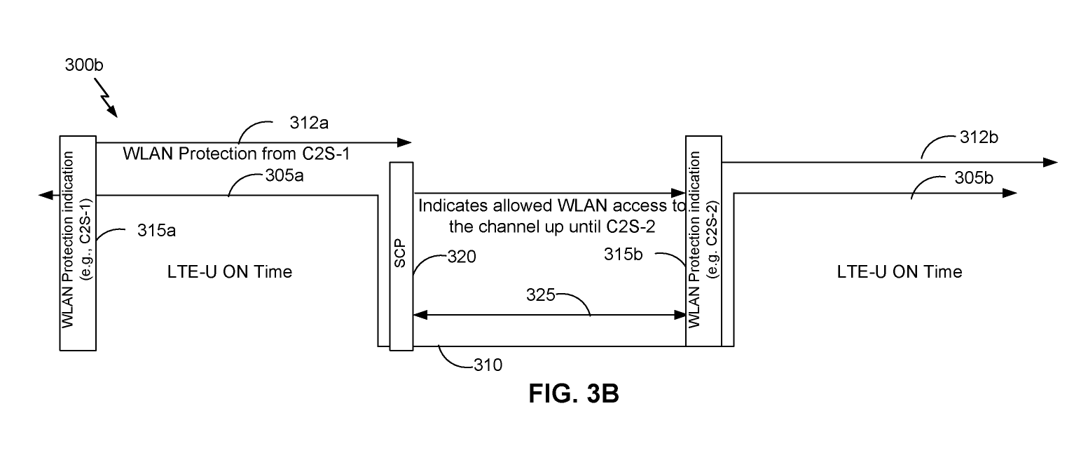

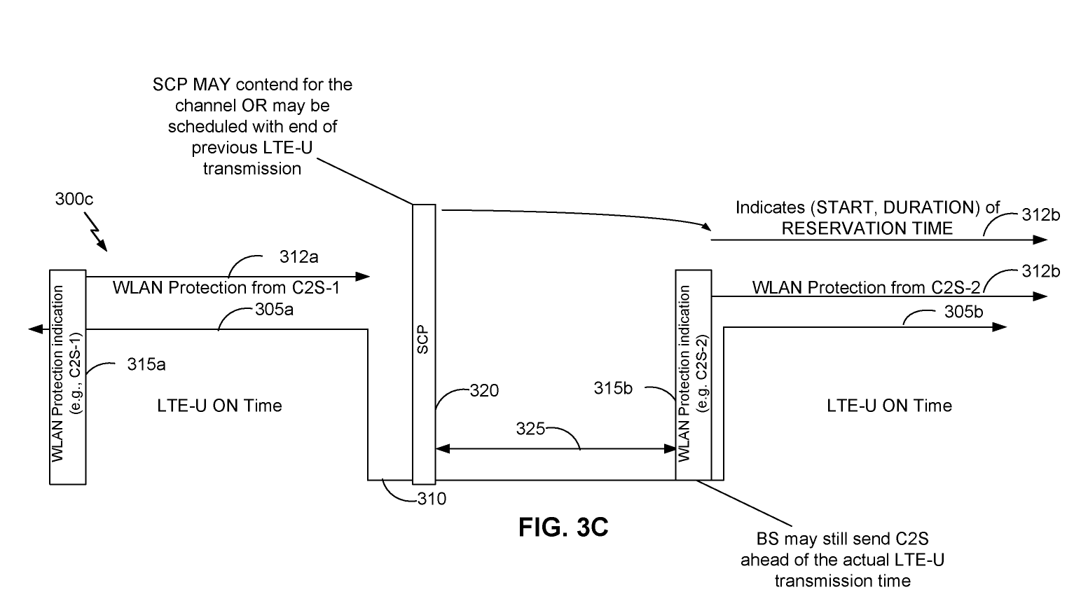

When in close proximity to the BS 104, AP 108 may also receive the transmissions made by BS 104. As such, AP 108 is also receiving the WLAN communication having been incorporated in the LTE-U communication and transmitted by BS 104. AP 108 while receiving such a transmission from BS 104 may defer transmission of its own WLAN communication in order to receive the SCP communication. As such, the SCP communication transmitted by BS 104 may continue and be received at STA 106 at possibly a reduced level of interference or no interference from possible WLAN transmissions by AP 108. Other WLAN devices in the wireless communication system 100 receiving the WLAN communication having been incorporated in the LTE-U communication and transmitted by BS 104 may also defer transmission of their own WLAN communication or may communicate by transmitting on a different channel than the frequency channel used for the LTE-U communication. The WLAN communication having been incorporated in the LTE-U communication, as such, protects transmission and reception of the SCP communication at a reduced level of interference or no interference from other possible WLAN transmissions in the wireless communication system 100. Various examples of the WLAN communication protecting the SCP communication, and subsequent use of the SCP for transmission of WLAN communications by WLAN devices, are shown and described below with respect to FIGS. 3A-3C.

FIG. 3A illustrates a time sequence diagram 300a of exemplary communications between LTE and WLAN devices, according to one embodiment. This embodiment illustrates an exemplary communication exchange within wireless communication system 100 of FIG. 1. Although FIG. 3A is described with respect to LTE-U communications, the teachings herein are applicable to coexistence between other sets of wireless communications technologies. For example, in some embodiments, LTE-U communications can be replaced with 802.11ax communications. Although various communications are shown, additional communications can be added, any communication shown can be omitted, and the timing or order of communications rearranged.

In the illustrated embodiment of FIG. 3A, the BS 104 transmits a first LTE-U waveform 305a and a second LTE-U waveform 305b separated by a notch 310. In some embodiments, each LTE-U waveform 305a-305b can be between about 10 ms and about 20 ms. In some embodiments, notch 310 can be between about 1 ms and about 2 ms.

Prior to the end of the first LTE-U waveform 305a, and thus prior to the start of notch 310, the BS 104 transmits a first WLAN protection indication 315a. In some embodiments, the WLAN modem 238 (FIG. 2) can transmit the first WLAN protection indication 315a, for example via coordination with the LTE modem 234 (FIG. 2). In various embodiments, the first WLAN protection indication 315a can include a transmission reserving the wireless medium that is decodable by, for example, an 802.11 device. In some embodiments, the first WLAN protection indication 315a can include, for example, a clear to send (CTS)-to-self (C2S) packet indicating that the wireless medium is reserved for a specified period of time. In other embodiments, other packets with a valid duration field can be used to reserve the medium. In some embodiments the protection indications (for example, communications 315a and 315b) can be transmitted in a non-HT duplicate mode of transmission.

In some embodiments, the first WLAN protection indication 315a can reserve the wireless medium until at least transmission of a second WLAN protection indication 315b. For example, the first WLAN protection indication 315a can indicate that receiving STAs should set their network allocation vectors (NAVs) 312a until at least the start (or, in some embodiments, end) of the transmission of the second WLAN protection indication 315b.

In some embodiments, the first WLAN protection indication 315a can indicate that receiving STAs should set their NAV time period 312a until a time beyond transmission of the second WLAN protection indication 315b. For example, the first WLAN protection indication 315a can indicate that receiving STAs should set their NAV time period 312a until the start of the second LTE-U waveform 305b, or later. The first WLAN protection indication 315a serves to reserve at least a portion of notch 310 for transmission by a subset of WLAN devices capable of decoding a selective contention period (SCP) announcement 320.

The SCP announcement 320 can indicate that the subset of WLAN devices capable of decoding the SCP announcement 320 can access the wireless medium regardless of any prior wireless medium reservation by an LTE-U device (such as the BS 104). For example, the SCP announcement 320 can indicate that the subset of WLAN devices capable of decoding the SCP announcement 320 should clear their NAV. The BS 104 can transmit the SCP announcement 320 immediately after the end of the first LTE-U waveform 305a, a set time after the end of the first LTE-U waveform 305a (for example, a SIFS time), or another time after the end of the first LTE-U waveform 305a (or in some embodiments, before).

In an embodiment, the SCP announcement 320 indicates that the subset of WLAN devices capable of decoding the SCP announcement 320 should only clear NAVs set by LTE-U devices. In some embodiments, the SCP announcement 320 can apply to only a subset of devices capable of decoding the SCP announcement 320 such as, for example, those explicitly identified (such as by address, group, access category, etc.).

In various embodiments, the SCP announcement 320 can overload an existing frame type, can include a control frame, and/or can include a public action frame (an example of a management frame). In some embodiments, the SCP announcement 320 can indicate an expiration time when the medium will become busy. For example, the SCP announcement 320 can indicate when the subset of WLAN devices capable of decoding the SCP announcement 320 can access the wireless medium until the start of the second WLAN protection indication 315b, the start of the second LTE-U waveform 305b, etc. In some embodiments, the SCP announcement 320 can indicate a duration of time (for example, selective contention period 325) during which the subset of WLAN devices capable of decoding the SCP announcement 320 can contend for the wireless medium.

In various embodiments, the SCP announcement 320 can allow selective contention beginning at a time after transmission of the SCP announcement (such as immediately after, or a SIFS after) and ending at a start time of the second WLAN protection indication 315b, an end time of the second WLAN protection indication 315b, or a start time of the second LTE-U waveform 305b. By identifying an end time of selective contention period 325, the SCP announcement 320 can improve the chances that a STA will receive the second WLAN protection indication 315b and reduce the likelihood of interference with the second LTE-U waveform 305b. In some embodiments, the SCP announcement 320 can include an identification (such as by address, group, access category, etc.) of STAs to which the SCP announcement 320 is targeted and which can hence access the medium during selective contention period 325.

Prior to the start of the second LTE-U waveform 305b, the BS 104 transmits the second WLAN protection indication 315b. In some embodiments, the WLAN modem 238 (FIG. 2) can transmit the second WLAN protection indication 315b, for example via coordination with the LTE modem 234 (FIG. 2). In various embodiments, the second WLAN protection indication 315b can include a transmission reserving the wireless medium that is decodable by, for example, an 802.11 device. In some embodiments, the second WLAN protection indication 315b can include, for example, a clear to send (CTS)-to-self (C2S) packet indicating that the wireless medium is reserved for a specified period of time. In other embodiments, other medium reservation packets can be used.

In some embodiments, the second WLAN protection indication 315b can reserve the wireless medium until at least transmission of a next WLAN protection indication (not shown). For example, the second WLAN protection indication 315b can indicate that receiving STAs should set their network allocation vectors (NAVs) 312b until at least the start (or, in some embodiments, end) of the next WLAN protection indication (not shown). In some embodiments, the second WLAN protection indication 315b can reserve the wireless medium until at least the completion of transmission of the LTE-U waveform 305b on-time or at least until the transmission of a CF-end frame (not shown) marking the end of the LTE-U waveform 305b on time.

As discussed with respect to FIG. 3A, in some embodiments the first WLAN protection indication 315a, in conjunction with the SCP announcement 320, is configured to allow only a subset of STAs to contend during selective contention period 325. In other embodiments, the first WLAN protection indication 315a, in conjunction with the SCP announcement 320, can be configured to allow all WLAN STAs to transmit during selective contention period 325. Although such configuration allows more WLAN devices to transmit, in some embodiments, not all WLAN devices can understand the SCP announcement 320. Accordingly, some WLAN devices may continue transmitting over the second LTE-U waveform 305b.

FIG. 3B illustrates a time sequence diagram 300b of exemplary communications between LTE and WLAN devices, according to another embodiment. This embodiment illustrates an exemplary communication exchange within wireless communication system 100 of FIG. 1. Although FIG. 3B is described with respect to LTE-U communications, the teachings herein are applicable to coexistence between other sets of wireless communications technologies. For example, in some embodiments, LTE-U communications can be replaced with 802.11ax communications. Although various communications are shown, additional communications can be added, any communication shown can be omitted, and the timing or order of communications rearranged.

In the illustrated embodiment of FIG. 3B, the BS 104 transmits a first LTE-U waveform 305a and a second LTE-U waveform 305b separated by a notch 310. In some embodiments, each LTE-U waveform 305a-305b can be between about 10 ms and about 20 ms. In some embodiments, notch 310 can be between about 1 ms and about 2 ms.

Prior to the end of the first LTE-U waveform 305a, and thus prior to the start of notch 310, the BS 104 transmits a first WLAN protection indication 315a. In some embodiments, the WLAN modem 238 (FIG. 2) can transmit the first WLAN protection indication 315a, for example via coordination with the LTE modem 234 (FIG. 2). In various embodiments, the first WLAN protection indication 315a can include a transmission reserving the wireless medium that is decodable by, for example, an 802.11 device. In some embodiments, the first WLAN protection indication 315a can include, for example, a clear to send (CTS)-to-self (C2S) packet indicating that the wireless medium is reserved for a specified period of time. In other embodiments, other medium reservation packets can be used.

In some embodiments, the first WLAN protection indication 315a can reserve the wireless medium until at least transmission of the SCP announcement 320. For example, the first WLAN protection indication 315a can indicate that receiving STAs should set their network allocation vectors (NAVs) until at least the start (or, in some embodiments, end) of the selective contention period (SCP) announcement 320.

In some embodiments, the first WLAN protection indication 315a can indicate that receiving STAs should set their NAVs until a time beyond transmission of the SCP announcement 320. For example, the first WLAN protection indication 315a can indicate that receiving STAs. The first WLAN protection indication 315a serves to reserve at least a portion of notch 310 for transmission of the SCP announcement 320.

The SCP announcement 320 can indicate that the subset of WLAN devices capable of decoding the SCP announcement 320 can access the wireless medium regardless of any prior wireless medium reservation by an LTE-U device (such as the BS 104). For example, the SCP announcement 320 can indicate that the subset of WLAN devices capable of decoding the SCP announcement 320 should clear their NAV. The BS 104 can transmit the SCP announcement 320 immediately after the end of the first LTE-U waveform 305a, a set time after the end of the first LTE-U waveform 305a (for example, a SIFS time), or another time after the end of the first LTE-U waveform 305a (or in some embodiments, before). In some embodiments, the BS 104 can contend for transmission of the SCP announcement 320 during notch 310.

In an embodiment, the SCP announcement 320 indicates that the subset of WLAN devices capable of decoding the SCP announcement 320 should only clear NAVs set by LTE-U devices. In some embodiments the SCP announcement may indicate to another subset of users that they may not access the medium (i.e., they must set their NAV) during the selective contention period 325. In some embodiments, the SCP announcement 320 can apply to only a subset of devices capable of decoding the SCP announcement 320 such as, for example, those explicitly identified (such as by address, group, access category, etc.). In some embodiments, the SCP announcement 320 does not indicate that the WLAN devices should clear their NAV.

In various embodiments, the SCP announcement 320 can overload an existing frame type, can include a control frame, and/or can include a public action frame (an example of a management frame). In some embodiments, the SCP announcement 320 can indicate an expiration time when the medium will become busy. For example, the SCP announcement 320 can indicate when the subset of WLAN devices capable of decoding the SCP announcement 320 can access the wireless medium until the start of the second WLAN protection indication 315b, the start of the second LTE-U waveform 305b, etc. In some embodiments, the SCP announcement 320 can indicate a duration of time (for example, selective contention period 325) during which the subset of WLAN devices capable of decoding the SCP announcement 320 can contend for the wireless medium.

In various embodiments, the SCP announcement 320 can allow selective contention beginning at a time after transmission of the SCP announcement (such as immediately after, or a SIFS after) and ending at a start time of the second WLAN protection indication 315b, an end time of the second WLAN protection indication 315b, or a start time of the second LTE-U waveform 305b. By identifying an end time of selective contention period 325, the SCP announcement 320 can improve the chances that a STA will receive the second WLAN protection indication 315b and reduce the likelihood of interference with the second LTE-U waveform 305b. In some embodiments, the SCP announcement 320 can include an identification (such as by address, group, access category, etc.) of STAs to which the SCP announcement 320 applies.

Prior to the start of the second LTE-U waveform 305b, the BS 104 transmits the second WLAN protection indication 315b. In some embodiments, the WLAN modem 238 (FIG. 2) can transmit the second WLAN protection indication 315b, for example via coordination with the LTE modem 234 (FIG. 2). In various embodiments, the second WLAN protection indication 315b can include a transmission reserving the wireless medium that is decodable by, for example, an 802.11 device. In some embodiments, the second WLAN protection indication 315b can include, for example, a clear to send (CT S)-to-self (C2S) packet indicating that the wireless medium is reserved for a specified period of time. In other embodiments, other packets with a valid duration field may be used to reserve the medium. In some embodiments the protection indications (for example, communications 315a and 315b) can be transmitted in a non-HT duplicate mode of transmission.

In some embodiments, the second WLAN protection indication 315b can reserve the wireless medium until at least transmission of a next WLAN protection indication (not shown). For example, the second WLAN protection indication 315b can indicate that receiving STAs should set their network allocation vectors (NAVs) until at least the start (or, in some embodiments, end) of the next WLAN protection indication (not shown). In some embodiments, the second WLAN protection indication 315b can reserve the wireless medium until at least the end of transmission of the LTE-U waveform 305b on time or at least until the transmission of a CF-end frame (not shown) marking the end of the LTE-U waveform 305b on time.

As discussed above, in the embodiment of FIG. 3B, the first WLAN protection indication 315a does not protect the entire notch 310. Accordingly, in some embodiments, at least one device that is not capable of decoding the SCP announcement 320 can transmit during notch 310. Because the device that is not capable of decoding the SCP announcement 320 will not know when to stop transmitting (in order to allow the BS 104 to transmit the second WLAN protection indication 315b and/or the second LTE-U waveform 305b), chances of interference increase. For example, the device that is not capable of decoding the SCP announcement 320 could continue transmitting during the second WLAN protection indication 315b, in which case it would not set its NAV.

In some embodiments, devices receiving the SCP announcement 320 can interpret the SCP announcement 320 as an indication not to transmit after a certain time. For example, with respect to FIG. 3B, the SCP announcement 320 can be interpreted as an indication not to transmit after the start of the second WLAN protection indication 315b. Thus, in some embodiments, devices receiving the SCP announcement 320 can set their NAV to a maximum or default value. The BS 104 can be configured to transmit a CF-end frame to clear the NAV when the reservation has ended. In other embodiments, the SCP announcement 320 can indicate that receiving devices should set their NAV long enough to receive the second WLAN protection indication 315b, which can provide further indication of medium reservation time. In some embodiments, the SCP announcement 320 can indicate a specific time at which any pending transmission should terminate, but after which (or a specific duration such an EIFS or SIFS after which) the SCP announcement 320 does not disallow new transmissions. In some embodiments, discussed below with respect to FIG. 3C, the SCP announcement 320 can indicate a duration, beyond a start time, for which a receiving device should not transmit.

FIG. 3C illustrates a time sequence diagram 300c of exemplary communications between LTE and WLAN devices, according to another embodiment. This embodiment illustrates an exemplary communication exchange within wireless communication system 100 of FIG. 1. Although FIG. 3C is described with respect to LTE-U communications, the teachings herein are applicable to coexistence between other sets of wireless communications technologies. For example, in some embodiments, LTE-U communications can be replaced with 802.11ax communications. Although various communications are shown, additional communications can be added, any communication shown can be omitted, and the timing or order of communications rearranged.

In the illustrated embodiment of FIG. 3C, the BS 104 transmits a first LTE-U waveform 305a and a second LTE-U waveform 305b separated by a notch 310. In some embodiments, each LTE-U waveform 305a-305b can be between about 10 ms and about 20 ms. In some embodiments, notch 310 can be between about 1 ms and about 2 ms.

Prior to the end of the first LTE-U waveform 305a, and thus prior to the start of notch 310, the BS 104 transmits a first WLAN protection indication 315a. In some embodiments, the WLAN modem 238 (FIG. 2) can transmit the first WLAN protection indication 315a, for example via coordination with the LTE modem 234 (FIG. 2). In various embodiments, the first WLAN protection indication 315a can include a transmission reserving the wireless medium that is decodable by, for example, an 802.11 device. In some embodiments, the first WLAN protection indication 315a can include, for example, a clear to send (CTS)-to-self (C2S) packet indicating that the wireless medium is reserved for a specified period of time. In other embodiments, other medium reservation packets can be used.

In some embodiments, the first WLAN protection indication 315a can reserve the wireless medium until at least the end of the first LTE-U waveform 305a. For example, the first WLAN protection indication 315a can indicate that receiving STAs should set their network allocation vectors (NAVs) until at least the end of the first LTE-U waveform 305a. In other embodiments, the first WLAN protection indication 315a can reserve the wireless medium until at least the end of transmission of the SCP announcement 320.

In some embodiments, the first WLAN protection indication 315a can indicate that receiving STAs should set their NAVs until a time beyond transmission of the SCP announcement 320. For example, the first WLAN protection indication 315a can indicate that receiving STAs. The first WLAN protection indication 315a serves to reserve the wireless medium for at least a portion of the first LTE-U waveform 305a.

The SCP announcement 320 can indicate that the subset of WLAN devices capable of decoding the SCP announcement 320 can access the wireless medium regardless of any prior wireless medium reservation by an LTE-U device (such as the BS 104). For example, the SCP announcement 320 can indicate that the subset of WLAN devices capable of decoding the SCP announcement 320 should clear their NAV. The BS 104 can transmit the SCP announcement 320 immediately after the end of the first LTE-U waveform 305a, a set time after the end of the first LTE-U waveform 305a (for example, a SIFS time or a PIFS time), or another time after the end of the first LTE-U waveform 305a (or in some embodiments, before). In some embodiments, the BS 104 can contend for transmission of the SCP announcement 320 during notch 310.

In an embodiment, the SCP announcement 320 indicates that the subset of WLAN devices capable of decoding the SCP announcement 320 should only clear NAVs set by LTE-U devices. In some embodiments, the SCP announcement 320 can apply to only a subset of devices capable of decoding the SCP announcement 320 such as, for example, those explicitly identified (such as by address, group, access category, technology-type etc.). In some embodiments, the SCP announcement 320 does not indicate that the WLAN devices should clear their NAV.

In various embodiments, the SCP announcement 320 can overload an existing frame type, can include a control frame, and/or can include a public action frame (for example, a control frame or management frame). In some embodiments, the SCP announcement 320 can indicate an expiration time when the medium will become busy. For example, the SCP announcement 320 can indicate when the subset of WLAN devices capable of decoding the SCP announcement 320 can access the wireless medium until the start (or, in some embodiments, end) of the second WLAN protection indication 315b, the start of the second LTE-U waveform 305b, etc. In some embodiments, the SCP announcement 320 can indicate a duration of time (for example, selective contention period 325) during which the subset of WLAN devices capable of decoding the SCP announcement 320 can contend for the wireless medium.

In various embodiments, the SCP announcement 320 can allow selective contention beginning at a time after transmission of the SCP announcement (such as immediately after, or a SIFS after) and ending at a start time of the second WLAN protection indication 315b, an end time of the second WLAN protection indication 315b, or a start time of the second LTE-U waveform 305b. By identifying an end time of selective contention period 325, the SCP announcement 320 can improve the chances that a STA will receive the second WLAN protection indication 315b and reduce the likelihood of interference with the second LTE-U waveform 305b. In some embodiments, the SCP announcement 320 can include an identification (such as by address, group, access category, technology-type etc.) of STAs to which the SCP announcement 320 applies.

In various embodiments, the SCP announcement 320 can indicate a start time after which receiving devices should not transmit. The SCP announcement 320 can further indicate a duration for which receiving devices should not transmit. For example, in the illustrated embodiment, the start time is a start time of the second WLAN protection indication 315b. A duration can include, for example, a duration of the second LTE-U waveform 305b.

Prior to the start of the second LTE-U waveform 305b, the BS 104 transmits the second WLAN protection indication 315b. In some embodiments, the WLAN modem 238 (FIG. 2) can transmit the second WLAN protection indication 315b, for example via coordination with the LTE modem 234 (FIG. 2). In various embodiments, the second WLAN protection indication 315b can include a transmission reserving the wireless medium that is decodable by, for example, an 802.11 device. In some embodiments, the second WLAN protection indication 315b can include, for example, a clear to send (CT S)-to-self (C2S) packet indicating that the wireless medium is reserved for a specified period of time. In other embodiments, other medium reservation packets can be used. In some embodiments medium reservation packets are transmitted in a non-HT duplicate mode of transmission.

In some embodiments, the second WLAN protection indication 315b can reserve the wireless medium until at least transmission of a next WLAN protection indication (not shown). For example, the second WLAN protection indication 315b can indicate that receiving STAs should set their network allocation vectors (NAVs) until at least the start (or, in some embodiments, end) of the next WLAN protection indication (not shown).

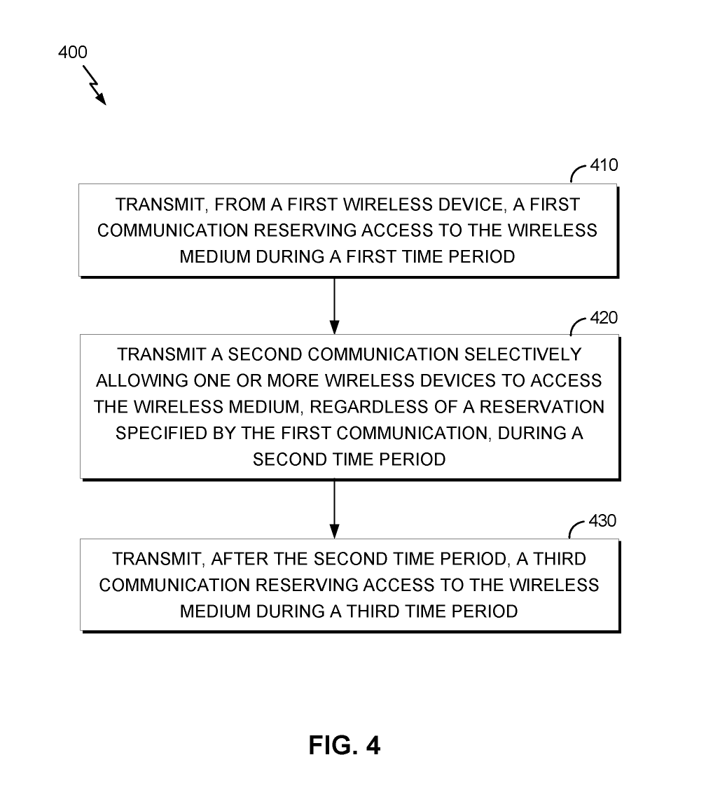

FIG. 4 shows a flowchart 400 for an example method of wireless communication that can be employed within wireless communication system 100 of FIG. 1. The method can be implemented in whole or in part by the devices described herein, such as wireless device 202 shown in FIG. 2. Although the illustrated method is described herein with reference to wireless communication system 100 discussed above with respect to FIG. 1 and communications 300a-300c discussed above with respect to FIGS. 3A-4C, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

First, at block 410, a first wireless device transmits a first communication reserving access to the wireless medium during a first time period. For example, the BS 104 can transmit the WLAN protection indication 315a, reserving the wireless medium for a time period 312a. The BS 104 can transmit the first communication, for example, to the STA 106 and/or the AP 108 (via broadcast or direct address). Accordingly, the STA 106 can receive the first communication and can refrain from transmitting during time period 312a.

In various embodiments, the first wireless device includes a long term evolution unlicensed (LTE-U) device and the first communication includes a wireless local area network (WLAN) communication. For example, the first wireless device can include the BS 104 and the first communication can include a WLAN protection indication 315a.

Next, at block 420, the first wireless device transmits a second communication selectively allowing one or more wireless devices to access the wireless medium, regardless of a reservation specified by the first communication, during a second time period. For example, the BS 104 can transmit the SCP announcement 320, indicating one or more STAs that are allowed to transmit during a selective contention period 325. The BS 104 can transmit the second communication, for example, to the STA 106 and/or the AP 108 (via broadcast or direct address). SCP announcement 320 can identify the STA 106. In embodiments where the STA 106 is capable of decoding the SCP announcement 320, and is identified in the SCP announcement 320, the STA 106 can transmit during selective contention period 325.

In various embodiments, the second time period can be a subset of the first time period. For example, the first time period can include the NAV time period 312a. The second time period can include selective contention period 325, which can be a subset of the NAV time period 312a.

In various embodiments, the second communication clears a network allocation vector (NAV), set by the first communication, for a duration of the second time period. For example, the first time period can include the NAV time period 312a. The second time period can include selective contention period 325, which can clear the NAV time period 312a.

In various embodiments, the second communication indicates a time after which the one or more wireless devices should not transmit. For example, the SCP announcement 320 can indicate that devices should not transmit after selective contention period 325 is ended, such as the start time of the C2S2 315b, the end time of the C2S2 315b, the start of the LTE-U waveform 305b, etc.

In various embodiments, the second communication indicates a duration for which the one or more wireless devices may transmit. For example, the SCP announcement 320 can indicate that devices are allowed to transmit during selective contention period 325.

In various embodiments, the second communication indicates a time at which the one or more wireless devices should set a network allocation vector (NAV) to a maximum value. For example, the SCP announcement 320 can indicate that the STA 106 should set it's NAV to maximum, at the start time of the C2S2 315b, the end time of the C2S2 315b, the start of the LTE-U waveform 305b, etc.

In various embodiments, the second communication identifies one or more access classes that are allowed to contend for access to the wireless medium. For example, the SCP announcement 320 can include one or more access class identifiers. In various embodiments, the second communication identifies one or more devices utilizing one or more technology types that are allowed to access the medium. For example, the SCP announcement 320 can include one or more device identifiers and/or technology identifiers.

In various embodiments, the second communication can be decodable only by a subset of a plurality of devices on a wireless network. For example, the SCP announcement 320 can be decodable only by SCP aware devices. In some embodiments, devices that cannot decode the SCP announcement 320 can be referred to as legacy devices. In various embodiments, the second communication identifies one or more wireless devices allowed to access the wireless medium. For example, the SCP announcement 320 can include one or more device identifiers

In various embodiments, the second communication includes a public action frame. In various embodiments, the second communication includes a control frame. In various embodiments, the second communication includes a frame carrying a vendor specific information element (IE).

Then, at block 430, the first wireless device transmits, after the second time period, a third communication reserving access to the wireless medium during a third time period. For example, the BS 104 can transmit the C2S2 315b, reserving the wireless medium for a time period 312b. The BS 104 can transmit the third communication, for example, to the STA 106 and/or the AP 108 (via broadcast or direct address). Accordingly, the STA 106 can receive the third communication and can refrain from transmitting during time period 312b.

In various embodiments, the third communication indicates that the one or more wireless devices should set a network allocation vector (NAV) to a second value, greater than the first value. For example, the BS 104 can transmit the C2S2 315b, which can set a NAV with an end time later than that set by the SCP announcement 320.

In various embodiments, the method can further include a transmitting a fourth communication clearing the NAV. For example, the BS 104 can transmit a CF-end packet (not shown) after transmitting the C2S2 315b. In various embodiments, the second communication indicates a time at which the one or more wireless devices should set or reset a network allocation vector (NAV) to a first value. For example, the BS 104 can transmit a SCP announcement 320 indicating a reservation time starting at a start time of the C2S2 315b, and lasting for a specified duration.

In an embodiment, the method shown in FIG. 4 can be implemented in a wireless device that can include a generating circuit and a transmitting circuit. Those skilled in the art will appreciate that a wireless device can have more components than the simplified wireless device described herein. The wireless device described herein includes only those components useful for describing some prominent features of implementations within the scope of the claims.

The generating circuit can be configured to generate the first, second, and third communications. In some embodiments, the generating circuit can be configured to perform at least blocks 410-430 of FIG. 4. The generating circuit can include one or more of processor 204 (FIG. 2), memory 206 (FIG. 2), and the DSP 220 (FIG. 2). In some implementations, means for generating can include the generating circuit.

The transmitting circuit can be configured to transmit first, second, and third communications. In some embodiments, the transmitting circuit can be configured to perform at least blocks 410-430 of FIG. 4. The transmitting circuit can include one or more of transmitter 210 (FIG. 2), antenna 216 (FIG. 2), and transceiver 214 (FIG. 2). In some implementations, means for transmitting can include the transmitting circuit.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of providing a window between long term evolution unlicensed (LTE-U) transmission times, during which wireless local area network (WLAN) devices can contend for access to a wireless medium, comprising:
transmitting, from a first wireless device, a first communication reserving access to the wireless medium during a first time period;
transmitting a second communication selectively allowing one or more wireless devices to access the wireless medium, regardless of a reservation specified by the first communication, during a second time period; and
transmitting, after the second time period, a third communication reserving access to the wireless medium during a third time period.

2. The method of claim 1, wherein the second time period is a subset of the first time period.

3. The method of claim 1, wherein the second communication clears a network allocation vector (NAV), set by the first communication, for the duration of the second time period.

4. The method of claim 1, wherein the second communication indicates a time after which the one or more wireless devices should not transmit.

5. The method of claim 1, wherein the second communication indicates a duration for which the one or more wireless devices may transmit.

6. The method of claim 1, wherein the second communication indicates a time at which the one or more wireless devices should set a network allocation vector (NAV) to a maximum value.

7. The method of claim 6, further comprising transmitting a fourth communication clearing the NAV.

8. The method of claim 1, wherein the second communication indicates a time at which the one or more wireless devices should set or reset a network allocation vector (NAV) to a first value.

9. The method of claim 8, wherein the third communication indicates that the one or more wireless devices should set a network allocation vector (NAV) to a second value, greater than the first value.

10. The method of claim 1, wherein the second communication is decodable only by a subset of a plurality of devices on a wireless network.

11. The method of claim 1, wherein the second communication identifies one or more wireless devices allowed to access the wireless medium.

12. The method of claim 1, wherein the second communication identifies one or more access classes that are allowed to contend for access to the wireless medium.

13. The method of claim 1, wherein the second communication identifies one or more devices utilizing one or more technology types that are allowed to access the medium.

14. The method of claim 1, wherein the first wireless device comprises a long term evolution unlicensed (LTE-U) device and the first communication comprises a wireless local area network (WLAN) communication.

15. The method of claim 1, wherein the second communication comprises a public action frame.

16. The method of claim 1, wherein the second communication comprises a control frame.

17. The method of claim 1, wherein the second communication comprises a frame carrying a vendor specific information element (IE).

18. An apparatus configured to communicate over a wireless medium, comprising:
a processor configured to:
generate a first communication reserving access to the wireless medium during a first time period;
generate a second communication selectively allowing one or more wireless devices to access the wireless medium, regardless of a reservation specified by the first communication, during a second time period; and
generate, for transmission after the second time period, a third communication reserving access to the wireless medium during a third time period; and
a transmitter configured to transmit the first, second, and third communications.

19. The apparatus of claim 18, wherein the second time period is a subset of the first time period.

20. The apparatus of claim 18, wherein the second communication clears a network allocation vector (NAV), set by the first communication, for the duration of the second time period.

21. The apparatus of claim 18, wherein the second communication indicates a time after which the one or more wireless devices should not transmit.

22. The apparatus of claim 18, wherein the second communication indicates a duration for which the one or more wireless devices may transmit.

23. The apparatus of claim 18, wherein the second communication indicates a time at which the one or more wireless devices should set a network allocation vector (NAV) to a maximum value.

24. The apparatus of claim 23, wherein the transmitter is further configured to transmit a fourth communication clearing the NAV.

25. The apparatus of claim 18, wherein the second communication indicates a time at which the one or more wireless devices should set or reset a network allocation vector (NAV) to a first value.

26. The apparatus of claim 25, wherein the third communication indicates that the one or more wireless devices should set a network allocation vector (NAV) to a second value, greater than the first value.

27. The apparatus of claim 18, wherein the second communication is decodable only by a subset of a plurality of devices on a wireless network.

28. The apparatus of claim 18, wherein the second communication identifies one or more wireless devices allowed to access the wireless medium.

29. An apparatus for communication over a wireless medium, comprising:
means for transmitting a first communication reserving access to the wireless medium during a first time period; and
means for transmitting a second communication selectively allowing one or more wireless devices to access the wireless medium, regardless of a reservation specified by the first communication, during a second time period; and
means for transmitting, after the second time period, a third communication reserving access to the wireless medium during a third time period.

30. A non-transitory computer-readable medium comprising code that, when executed, causes an apparatus to:
transmit a first communication reserving access to the wireless medium during a first time period; and
transmit a second communication selectively allowing one or more wireless devices to access the wireless medium, regardless of a reservation specified by the first communication, during a second time period; and
transmit, after the second time period, a third communication reserving access to the wireless medium during a third time period.
